(19) United States
(12) Patent Application Publication
(10) Pub. No.: US 2011/0233255 A1
(43) Pub. Date: Sep. 29, 2011

(54) Paper Towel Dispenser

(76) Inventor: Nick Y. Tiamson, Chicago, IL (US)

(21) Appl. No.: 12/748,512

(22) Filed: Mar. 29, 2010

(51) Int. Cl. A47K 10/38; A47K 10/22; B26F 3/02

(52) U.S. Cl. 225/77; 312/34.8

(57) ABSTRACT

A paper roll holder and dispenser having the ability to lock the roll in a non-rotating condition to allow the tear-off of individual sheets is described. The dispenser utilizes a tear bar coupled to a locking mechanism within the roll support to frictionally prevent rotation of the roll from the interior. An alternative dispenser utilizes a container with an inclined surface for retaining a paper roll at a feed opening during use. A pivotable tear bar positioned proximate the feed opening alternately allows dispensing of the paper from the feed opening and blocks dispensing from the feed opening when a tearing motion is applied to the tear bar.

### TECHNICAL FIELD OF THE INVENTION

The present device relates to a dispenser for paper towels. Particularly, the present device relates to a dispenser for paper towels with a tear feature to prevent unraveling of the roll during tear-off.

### BACKGROUND OF THE INVENTION

The various uses for the paper towel in homes, offices, restaurants and the like are far too numerous to list. The liquid-absorbent paper towels come in varying lengths, each sheet joined to another at perforated edges and packaged and sold in multi-sheet rolls under trademark names such as BOUNTY® (Proctor & Gamble Company), BRAWNY® (Fort James Corp.) and VIVA® (Kimberly-Clark Company). Paper towels are used to clean every imaginable mess in any imaginable place. The size of the mess determines the number of sheets to be used.

Dispensing of the individual sheets from a standard roll dispenser—where rolls are allowed to rotate about a spindle with little resistance—has been problematic at best. Unlike toilet paper, for example, the long tear length of paper towels requires a long steady motion to avoid unraveling the roll. Further, as paper towels continue to be made from sturdier paper stock or in multi-ply sheets, the tear perforations require greater force to separate each sheet from a roll. Without careful effort by the user, the result of a strong pull to tear the perforations may be the withdrawal of numerous unneeded sheets.

Some towel dispensing devices have been designed utilizing a spring-biased mechanism to ride against the roll. However, these mechanisms go too far. When applied, the mechanisms almost completely inhibit the paper towel roll from rotating, and the need for a greater number of sheets can be deterred. What is needed is a dispensing device which can dispense paper towels freely to a desired length and then permit easy tear off by inhibiting further movement of the towels.

Other prior art paper towel dispensing devices allow the user to halt the roll rotation with one hand while tearing sheets with the other hand. This solves the problem of controlling the length of towels dispensed, but it creates a potential bigger problem by requiring the use of two hands. Often the user may have only the use of a couple clean fingertips by which to grab the roll of towels.

The present invention solves these and other problems associated with prior art devices. Multiple embodiments of a paper towel dispenser are presented which have additional design and manufacturing advantages over such prior art devices.

### SUMMARY OF THE INVENTION

A number of embodiments of a paper roll holder and dispenser are herein described. The dispenser is generally comprised of the ability to restrict rotation of a roll of material to allow the tear-off of a desired length of individual sheets with the use of one hand.

Accordingly, in one embodiment of the disclosed device, the dispenser comprises a base, a roll support extending from the base and positioned to retain a roll of material on the base in a rotatable state, a tear bar attached to the base, extending substantially parallel to the roll support, and movable along and between a first position and a second position, and a braking member coupled to the tear bar and responsive to the movement of the tear bar. The braking member preferably inhibits rotation of the roll of material when the tear bar is in one of either the first position or the second position. Additionally, the braking member is preferably positioned within the roll support.

The disclosed dispenser may further comprise a pivot attached to the base and about which the tear bar and the braking member move. The pivot is preferably positioned on a bottom-side of the base so as not to detract from the aesthetics of the device. The braking member of the disclosed embodiment frictionally engages an interior of the roll of material when the tear bar is in either of the first position and the second position.

In another embodiment, the disclosed dispenser comprises a base having a support surface and a retaining surface, and a material feed opening defined between an edge of each of the support surface and the retaining surface. The support surface is positioned on the base at an angle such that a roll of material placed onto the support surface rolls, as a result of gravity, toward the retaining surface until it abuts the surface. In an addition to this embodiment, a tear bar is detachably connected via a pivot at the material feed opening.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated. Certain features, work pieces and environment of some figures have been omitted or shown in broken lines so as not to obscure other features of the figures.

FIG. 1 is a perspective view of an embodiment of an upright dispenser loaded with a roll of paper towels;

FIG. 2 is a perspective view of the embodiment of FIG. 1 without the roll of paper towels;

FIG. 3 is a side view of the dispenser of FIG. 1;

FIG. 4 is a partial side view showing the base of the dispenser of FIG. 1;

FIG. 5 is a bottom view of the dispenser of FIG. 1;

FIG. 6 is a cross-section of the base of another embodiment of the present invention;

FIG. 7 is a partial detail view showing a pivot for the embodiment of FIG. 6;

FIG. 8 is a perspective view of a base underside of the embodiment of FIG. 6 illustrating the use of a biasing mechanism;

FIG. 9 is a perspective view of an embodiment of a horizontal paper towel dispenser;

FIG. 10 is a perspective view of a tear bar used with the dispenser of FIG. 9;

FIG. 11 is a side view of the dispenser of FIG. 9 assembled with the tear bar of FIG. 10 in a closed position;

FIG. 12 is a side view of the dispenser of FIG. 9 assembled with the tear bar of FIG. 10 in an open position;

FIG. 13 is a close up of the tear bar of FIG. 11;

FIG. 14 is a perspective of another embodiment of a horizontal paper towel dispenser illustrating a top feed opening;

FIG. 15 is a perspective view of the embodiment of FIG. 9 including a pivoting face plate;

FIGS. 16-18 illustrate details of the embodiment of FIG. 15;

FIGS. 19-22 illustrate still another embodiment of a horizontal towel dispenser; and

FIG. 23 is a detailed view of one possible embodiment of the dispenser cutting bar.

### DETAILED DESCRIPTION OF PREFERRED EMBODIMENTS

While this invention is susceptible of embodiments in many different forms, there is shown in the drawings and will herein be described in detail, preferred embodiments of the invention with the understanding that the present disclosure is to be considered as an exemplification of the principles of the invention and is not intended to limit the broad aspect of the invention to the embodiments illustrated. While the invention is described in combination with a roll of common paper towels, it should be understood that the features of the invention could be applied to the dispensing of other tearable, not necessarily perforated, materials as well.

For purposes of the description, the various components of the invention are commonly numbered through the illustrated embodiments, with the exception that the first digit between common elements reflects the embodiment to which the element pertains—for example, element 21 would be element 121 in a second embodiment and element 221 in a third embodiment.

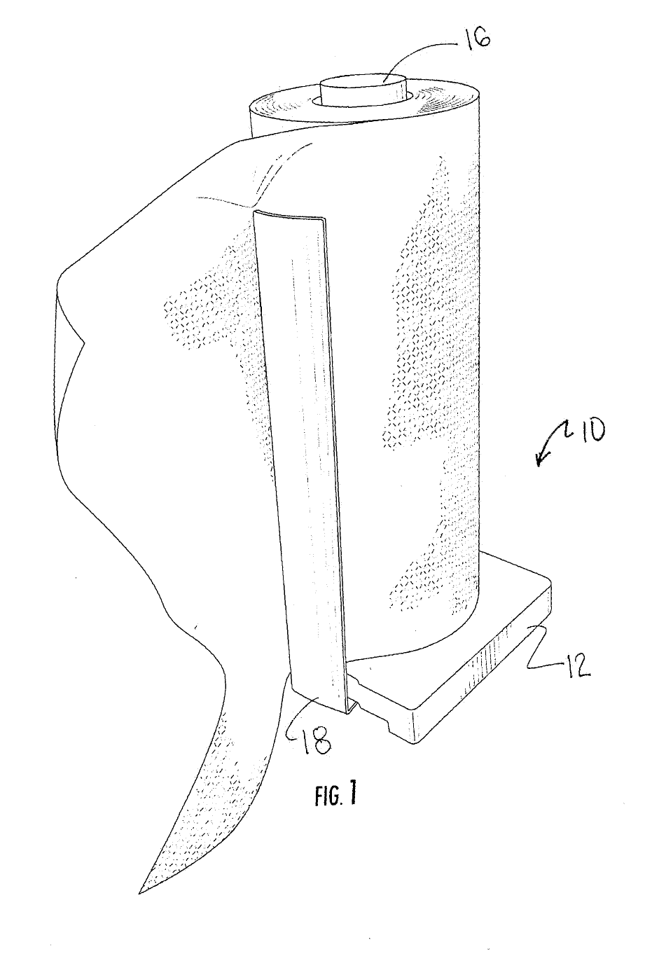

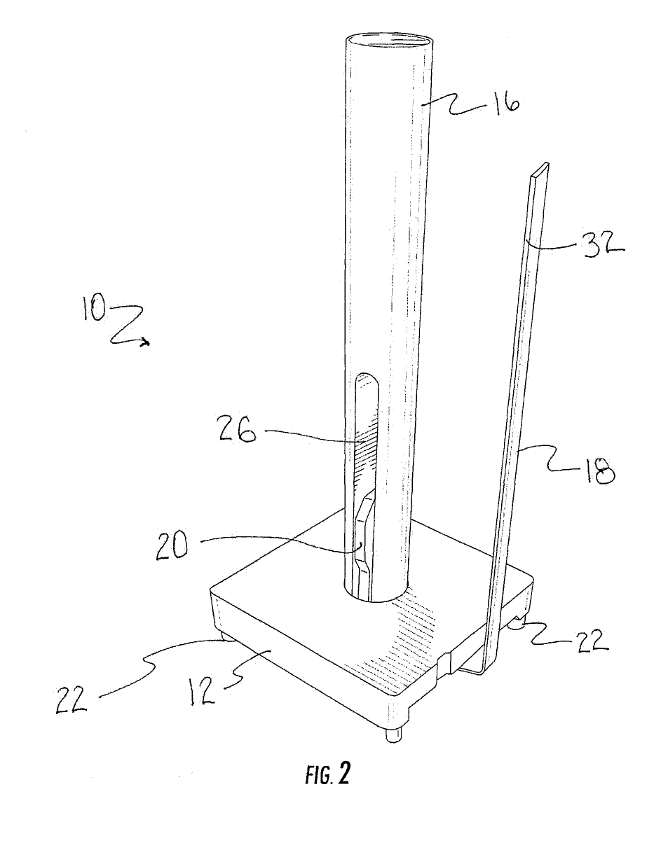

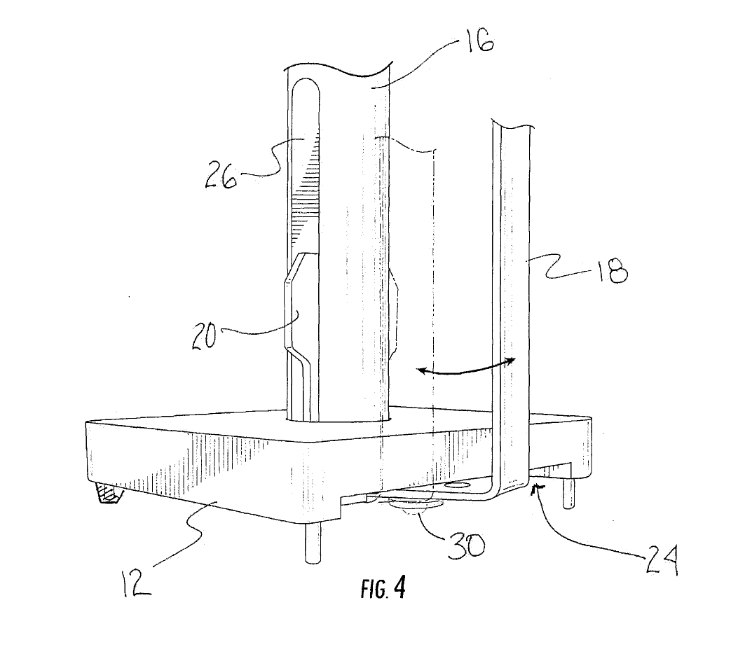

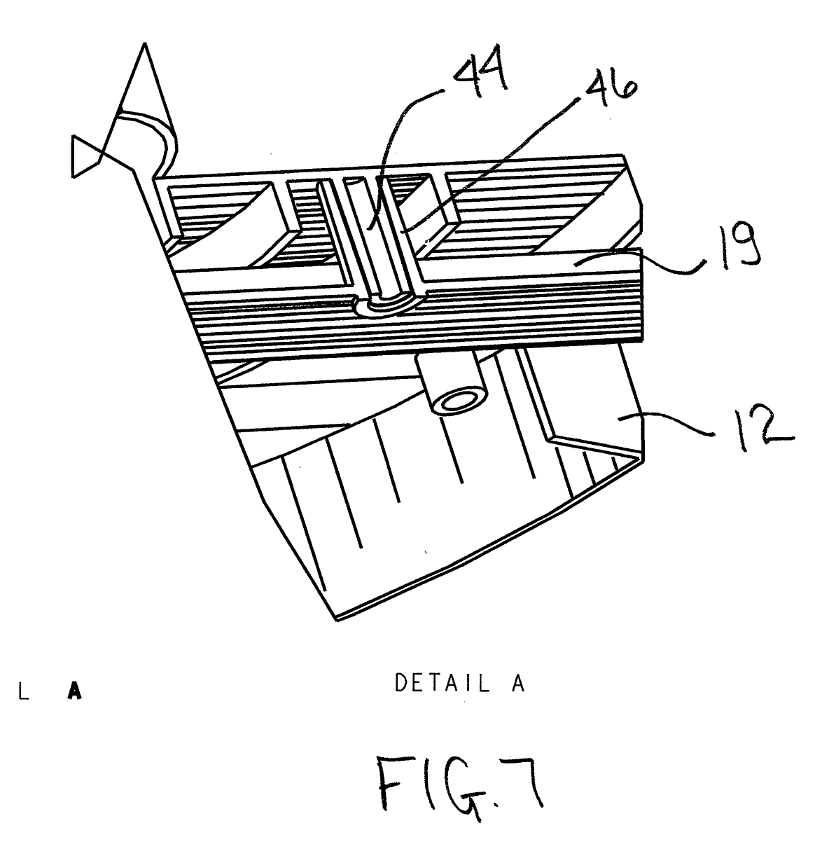

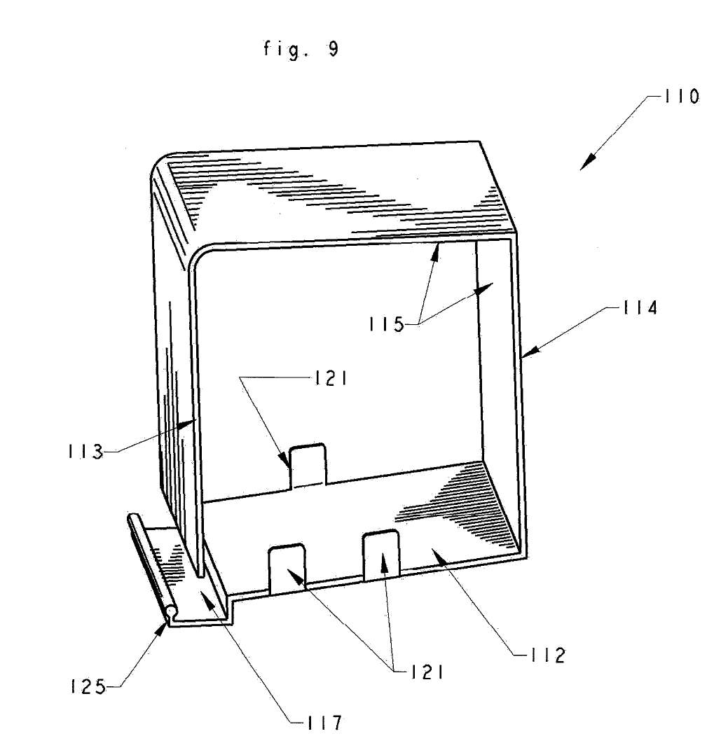

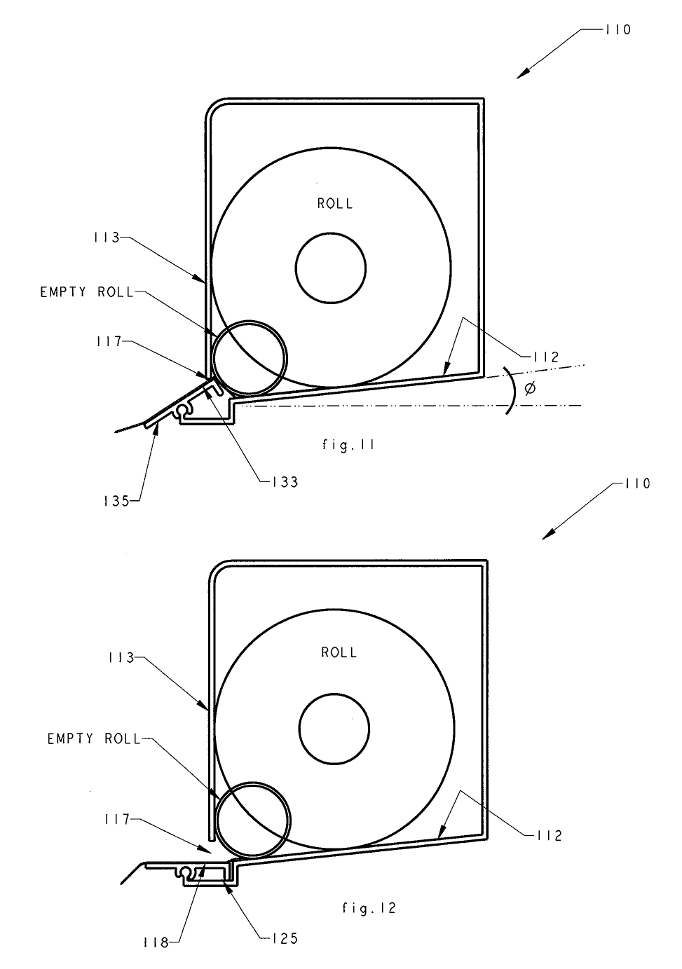

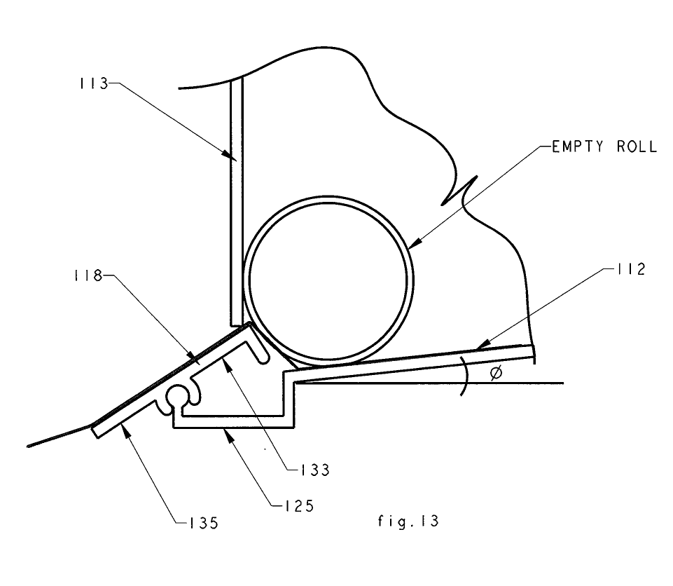

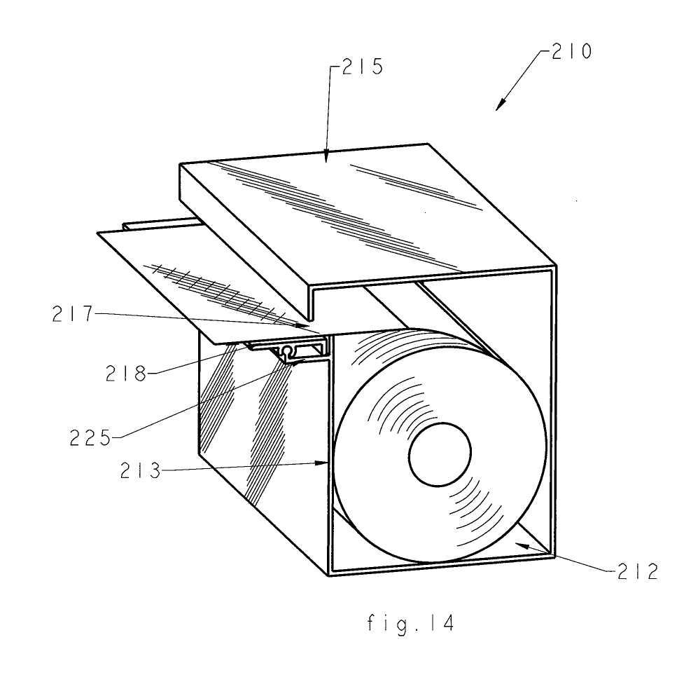

Referring to FIGS. 1-23, there is illustrated several embodiments of a paper towel dispenser, generally designated by the numerals 10 (vertical dispenser of FIGS. 1-8) and 110 (horizontal dispenser of FIGS. 9-23). The dispenser of FIGS. 1-8 is intended to be placed on a surface, such as a kitchen counter top, desk, work bench or the like, and retain a roll of paper towels in a vertical orientation. The dispenser 110 of FIGS. 9-23 may also be positioned on a surface, as above, as well as attached, for example, to a wall or under a cabinet, but with the roll being retained in a horizontal orientation.

Generally speaking, the dispenser 10 includes a base 12, a roll support 16 extending from the base 12, a tear bar 18 also attached to the base 12, and a braking member 20. The individual components can be manufactured from a variety of materials, including wood, plastic, metal, composites and any combination of these materials. The material of the components is best for determining the manner in which they are to be connected to one another. Such manufacturing choices are well within the knowledge of those skilled in the art to which the present invention pertains.

Referring first to FIGS. 1-5, one embodiment of a vertical or upright towel dispenser 10 is illustrated. The dispenser 10 includes a square base 12 having dimensions approximately equal the diameter of a roll of paper towels, though other shapes and sizes are possible. Padded feet 22 may be used on an underside of the base 12 to facilitate gripping of a surface (not shown) onto which the dispenser 10 is placed. The base 12 is preferably of a thickness to support an internal cavity 24 to enclose mechanisms described in detail below.

The roll support 16 is basically comprised of a rod about which a roll of towels can be placed to be retained on the base 12 in a rotatable state. The roll support 16 is shown to be centered on the base 12, but alternate positioning is possible. The dimensions (i.e., height and width) of the support 16 must be sufficient to allow insertion into a center opening on a roll of paper towels, and then retain the roll thereon. Preferably, the support 16 is fixed to the base 12 without the ability to rotate. A passage 26 is shown in the support 16 to permit travel of a braking member 20 described below.

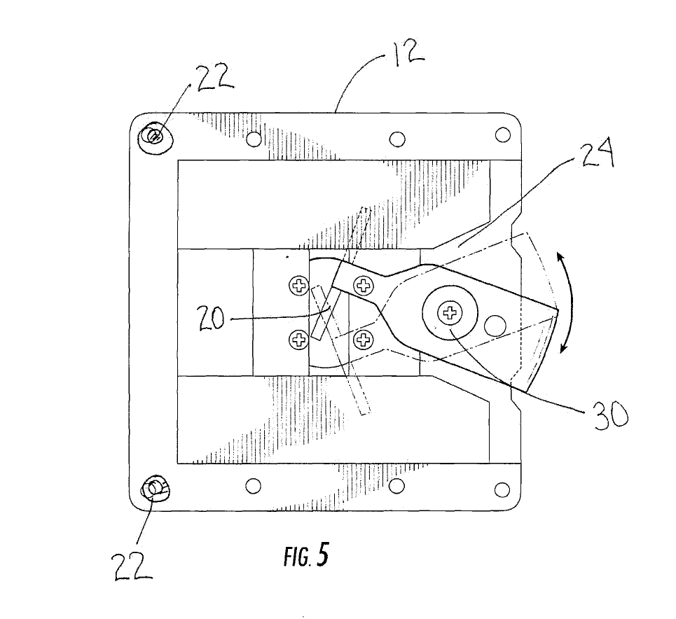

The tear bar 18 is preferably attached to an underside surface of the base 12, as shown in FIG. 5. The attachment of the bar 18 is achieved by a pivot 30 on the underside of the base 12. The pivot 30 allows the bar 18 freedom to move through and between a first position and a second position, where the base 12 acts as a stop to this motion. After turning toward an upper surface of the base 12, the tear bar 18 extends substantially parallel to the roll support 16. As illustrated, the tear bar 18 is a rigid strip intended to extend the approximate height of a standard roll of paper towels. The bar 18 may include serrated edges, for example, which facilitate tearing of the paper at desired lengths.

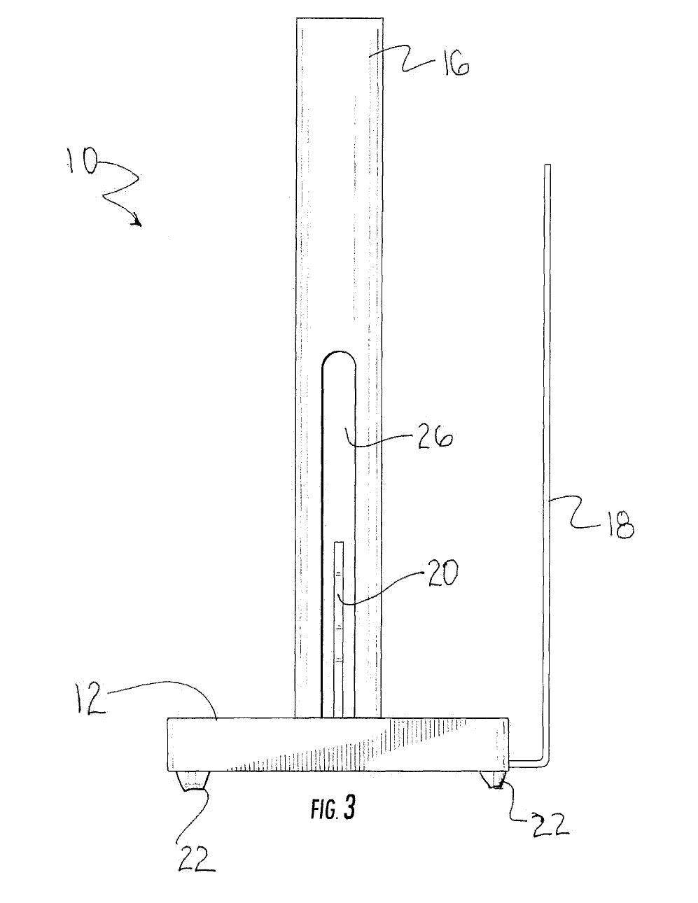

The braking member 20 is coupled to the tear bar 18, preferably as a single piece, and is therefore responsive to the movement of the tear bar 18. The braking member 20 pivots opposite the tear bar 18 as a result of the connection. As shown in FIG. 3, the braking member resides within the roll support 16, but is capable of pivoting to extend out at least one side of the support 16, and preferably, alternately, out both sides. When extended in this manner, the braking member 20 inhibits rotation of the roll of material by frictionally engaging the paper roll from its interior surface. As the movement of the braking member 20 is coupled to that of the tear bar 18, the braking member 20 moves to bear against the roll when the tear bar 18 is in one of either the first position or the second position.

The braking member 20, or at least an end or edge of the braking member 20, may comprise a material having a high coefficient of friction, such as rubber or a soft polymer, or the edge may have small teeth (not shown) to create stopping friction.

As an alternate configuration, though not shown, the braking member 20 may be outside and adjacent the roll support 16 so as to still frictionally engage the interior of the roll when the tear bar 18 is moved. The braking member 20 would have to be positioned close enough to the roll support 16 such that a roll would fit over both components.

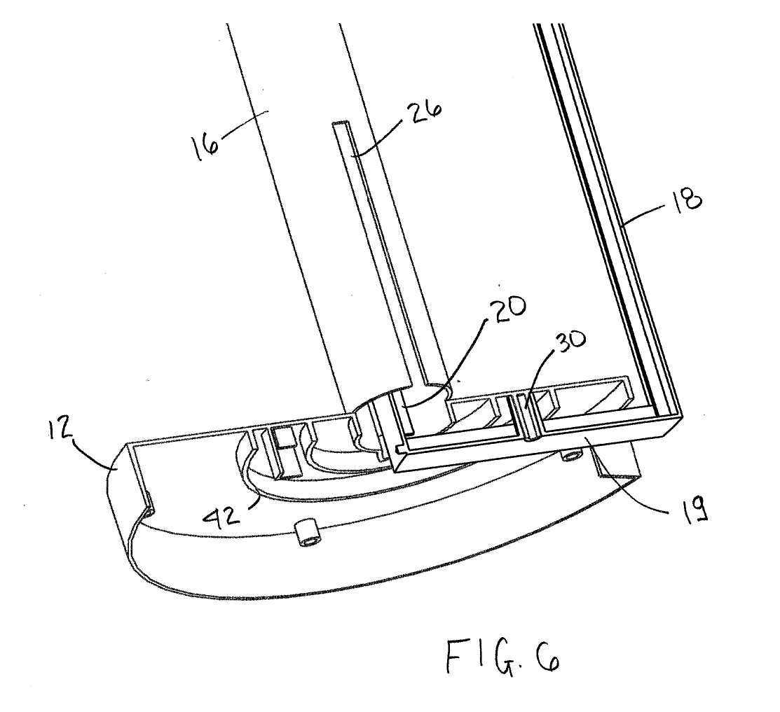

In the embodiment of FIGS. 6-8, the dispenser 10 is manufactured in four pieces (not including screws). The dispenser 10 includes a round base 12, a tear bar 16 integrally coupled, via connecting member 19, to a braking member 20, a roll support 18, and a cover plate 40. In the illustrated embodiment, each of the noted components is preferably made of a molded-plastic material to simplify manufacture and construction. The molded construction is also economical, as parts can be mass produced for quick assembly. To strength the molded parts, longitudinal or concentric ribs, such as the ribs 42 used on base 12, can be added.

Of particular significance in the molded dispenser 10 of FIGS. 6-8 is pivot 30, which is constructed by the mating of a first conical protuberance 44 on the underside of the base 12 and a second conical protuberance 46 on the connecting member 19. The outer surface of the first conical protuberance 44 is tapered to match the taper of the interior wall of the second conical protuberance 46. Smooth mating surfaces allow the first conical protuberance 44 to move within the second protuberance 46. The unique pivot 30 construction facilitates connection between the two protuberances, but also provides a more stable element, over a nut and bolt pivot point for example, as the braking member 20 and the tear bar 18 move back and forth.

To better accommodate movement of the tear bar 18 and prevent it from being inadvertently blocked, a recess area 48 is provided in base 12. The recess area 48 allows the tear bar 18 to remain within the peripheral bounds of the base 12, while still operating in either direction as described above. Similarly, the passage 26 of the support 16 is tightly toleranced to the dimensions of the braking member 20 in the molded embodiment.

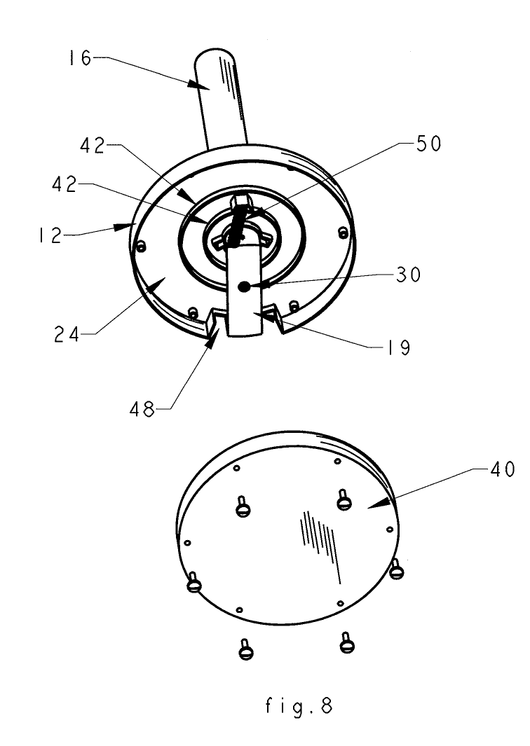

A compression spring 50 may be used in the present embodiment to provide greater stability in the movement of the tear bar 18. The spring 50 preferably has one end attached to the underside of the base 12 and the other end to a point on the tear bar 18/braking member 20 component. As shown in FIG. 8, the compression spring 50 biases the braking member 20, and therefore the tear bar 18, to one side or the other. A certain amount of force is required to compress the spring 50 as the tear bar 18 moves from a first position to a mid-point, and then the spring 50 biases the bar 18 in the other direction. The mechanism helps prevents the tear bar 18 from wobbling and from freely bouncing back and forth.

Finally, the cover plate 40 connects to the base 12 to protect the spring 50 and pivot 30 features from dust, dirt and the like. Six (6) screw holes align between the base 12 and the cover plate 40 to facilitate the connection. The cover plate 40 may also keep the second protuberance 46 from becoming unseated with the first conical protuberance 44 by supporting the connecting member 19 at the pivot point 30. The cover plate 40 may include, for example, rubber feet (not shown) or a rubber layer—or most any other suitable high-friction material, including many synthetics—to prevent sliding on counter surfaces.

With reference to FIGS. 9-13, an embodiment of a horizontal paper towel dispenser 110 is illustrated. The dispenser 110 generally comprises a housing 114 constructed from a series of surfaces including a base 112, a retaining surface 113, and adjoining surface(s) 115. A material feed opening 117, through which the paper towel is dispensed, is defined between an edge of each of the base 112 and the retaining surface 113. The dispenser 110, preferably open on at least one side, and most preferably on both sides, is preferably constructed to be mounted to a surface (e.g., a wall) via suitable mounting hardware (not shown).

The housing 114 is preferably made from one of either a metal or plastic material, though other materials such as wood, a laminate or composite may also be suitable. The surfaces of the housing 114 may be formed from a single piece of material—for example, stamped from a metal blank—or they may be formed of multiple pieces which are joined to one another by any known technique.

In use, a roll of paper towels can be placed within the housing 114 through an open side with a lead paper sheet being fed through the opening 117 to start the roll. Side flange(s) 121 may be used to keep the paper roll from accidentally exiting the housing 114 on an open side. The roll is supported on the base 112, which is preferably set at an incline. The incline biases, by gravity, a seated roll toward and into an abutting relationship with the retaining surface 113. The angle (A) of the inclined surface is preferably within the range of 5 to 30°, inclusive. As paper from the roll is pulled through the opening 117, the diminishing roll would still sit toward the opening 117.

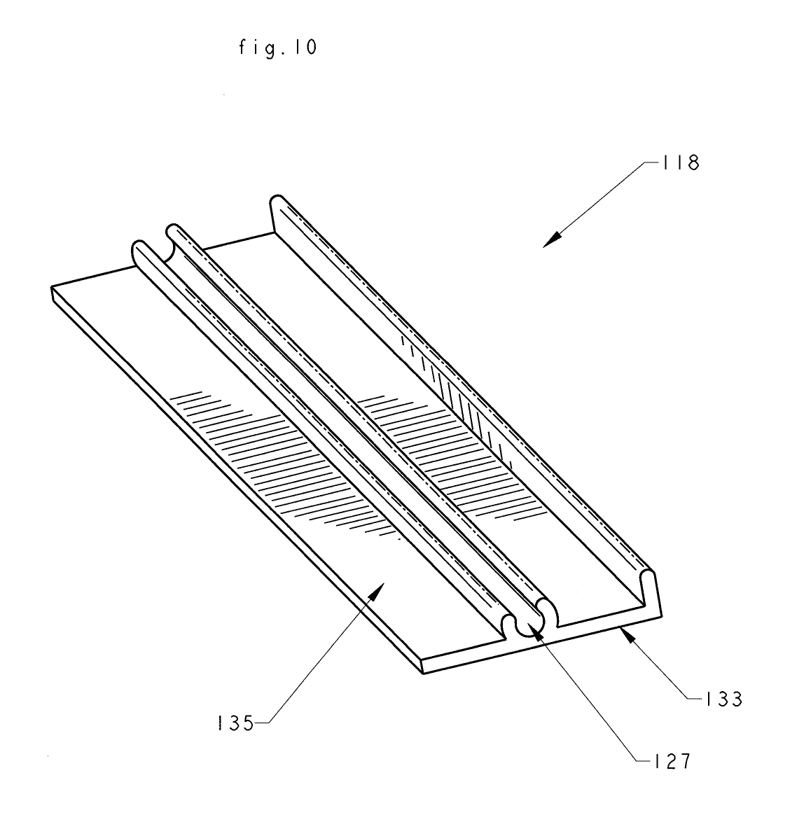

As shown in FIGS. 10-13, the dispenser 110 may further comprise a tear bar 118 attached to the base 112 at the material feed opening 117. A small lip 125 extending from the base 112 provides an attachment point—via a snap fit connection—and acts as a pivot for the tear bar 118. Preferably, the tear bar 118 extends the length of the feed opening 117 and includes a snap groove 127 along a middle of an underside surface which connects to the lip 125. As shown, the bar 118 is also detachable from the lip 125, if desired.

The groove 127 divides the bar 118 into opposing ends and serves as the pivot point when attached to the lip 125. A first end 133 of the bar 118 pivots upward to abut the retaining surface 113 and pinches the paper towel feed there between. This prevents paper from advancing from the feed opening 117. A second end 135 of the bar 118 pivots downward, as a result of force applied by a user attempting to tear a sheet of paper from the roll, and may include an edge to facilitate the tearing of the paper. The two ends 133, 135 of the bar 118 may be balanced such that the paper is pinched or the feed opening blocked to prevent inadvertent dispensing. By pulling the paper feed horizontally from the opening 117, the paper pivots the first end 133 of the bar 118 downward to release the paper for dispensing.

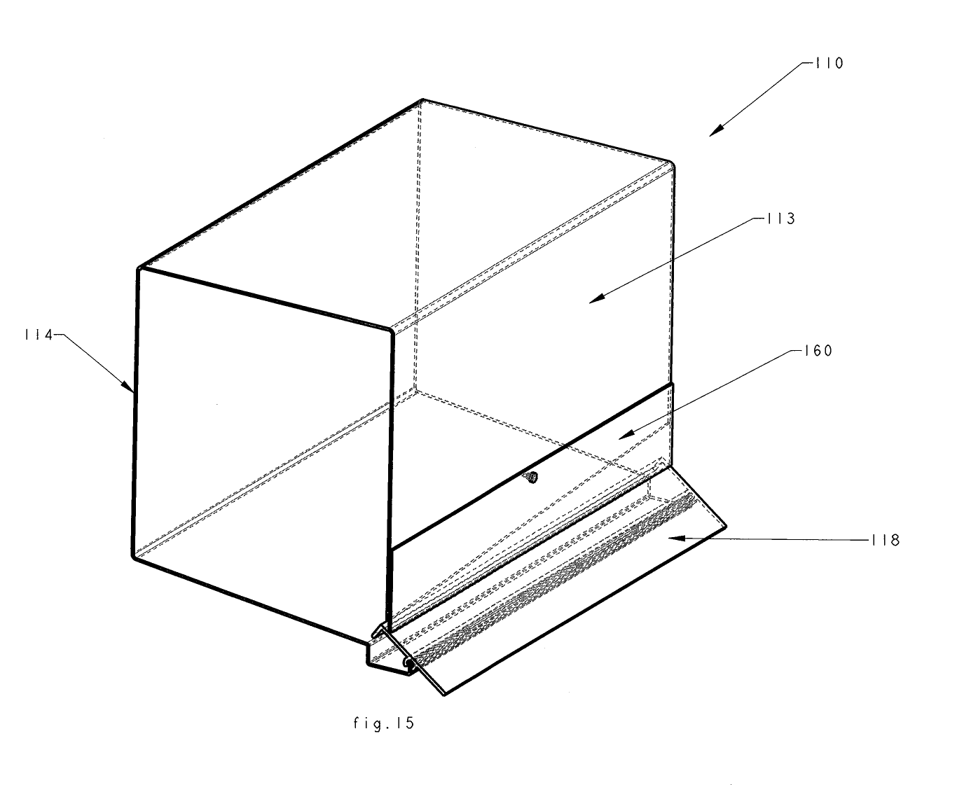

FIG. 14 illustrates another embodiment of the horizontal dispenser 110. The illustrated dispenser 110 is substantially identical to the dispenser 110 of FIGS. 9-13, except that the feed opening 117 is positioned at an upper end of the retaining surface 113. The base 112, though angled as previously discussed, does not form an edge of the opening 117. Instead, an adjoining surface 115 of the housing 114 forms the opening 117 with the retaining surface 113. A lip 125, therefore, extends from the retaining surface 113 to provide a pivot point for the tear bar 118. The action of the tear bar 118 is as described above.

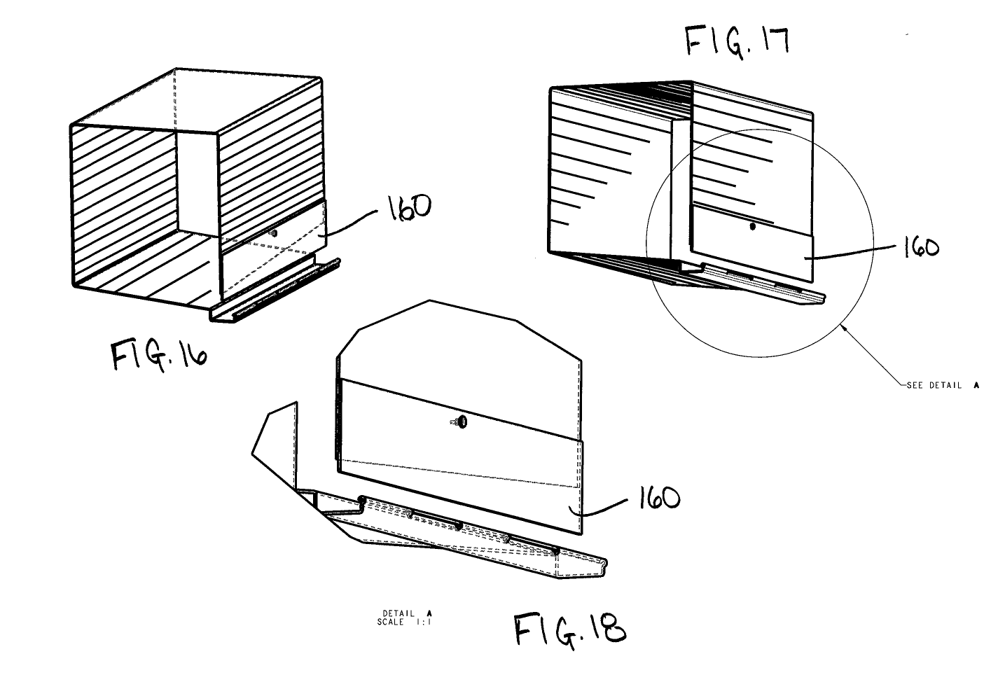

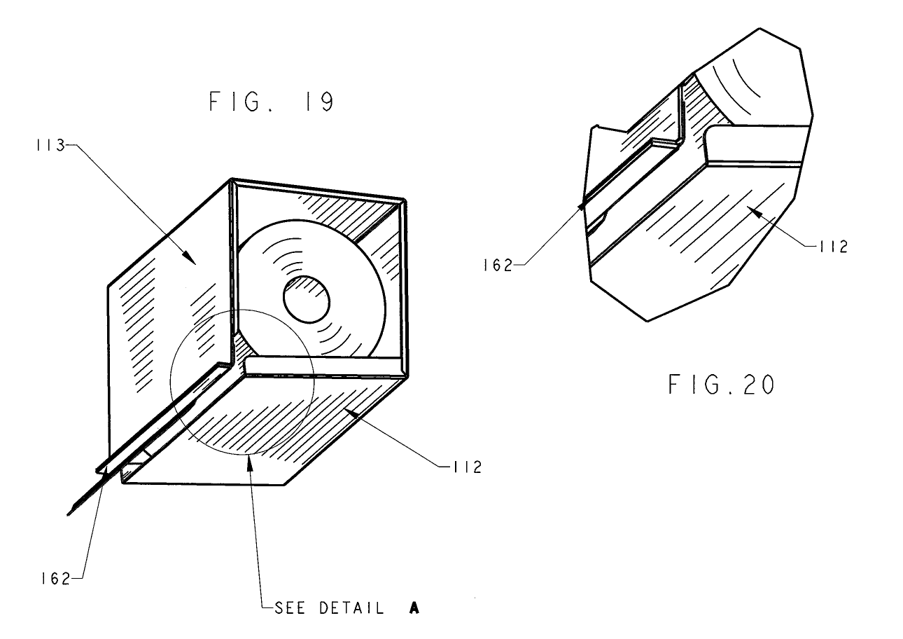

FIGS. 15-18 illustrate yet another variation on the horizontal dispenser 110. In the illustrated embodiment, the dispenser 110 includes a pivoting face plate 160 attached to the retaining surface 113. The pivoting face plate 160 serves a couple purposes. First, the width of opening 117 is typically fixed, so the pivoting face plate 160 may allow a certain amount of variation in that feature to accommodate varied material thicknesses and stiffnesses. Second, manufacturing anomalies and typical wear-and-tear from use might result in an uneven opening width (see phantom line of FIGS. 16-18). The uneven opening would cause the tear bar 118 to abut at less than all points of the retaining surface 113 resulting in a more difficult tear of the paper. The pivoting face plate 160 would guarantee that the discharging paper would be engaged consistently at the opening 117 along its full width.

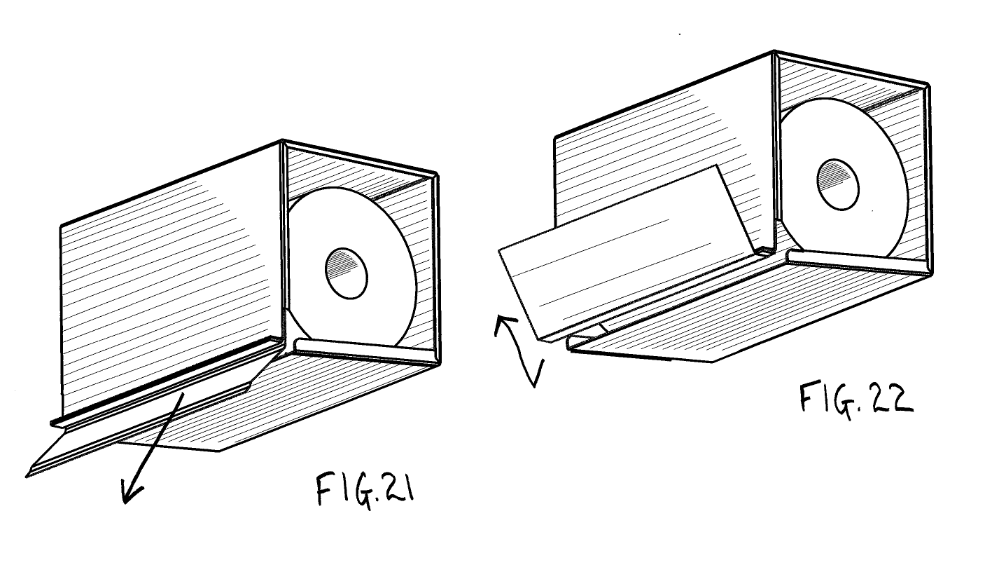

Still another variation of the horizontal dispenser 110 is shown in FIGS. 19-23. This design includes a horizontal upper lip 162 attached to the retaining surface 113. The upper lip 162 replaces lip 125 in previous embodiments. The upper lip 162, which could also be used on the embodiment of FIG. 14 having an upper opening 117, comprises a short extension having a strip, coating, layer or laminate of a higher friction material, such as a neoprene rubber or the like, on the surface facing opening 117. The friction material “grabs and holds” the paper when it is pulled upward against the lip 162, preventing further advancement. This facilitates tearing of the paper. Conceivably, the friction material may be continuous or intermittent on the surface of the lip 162.

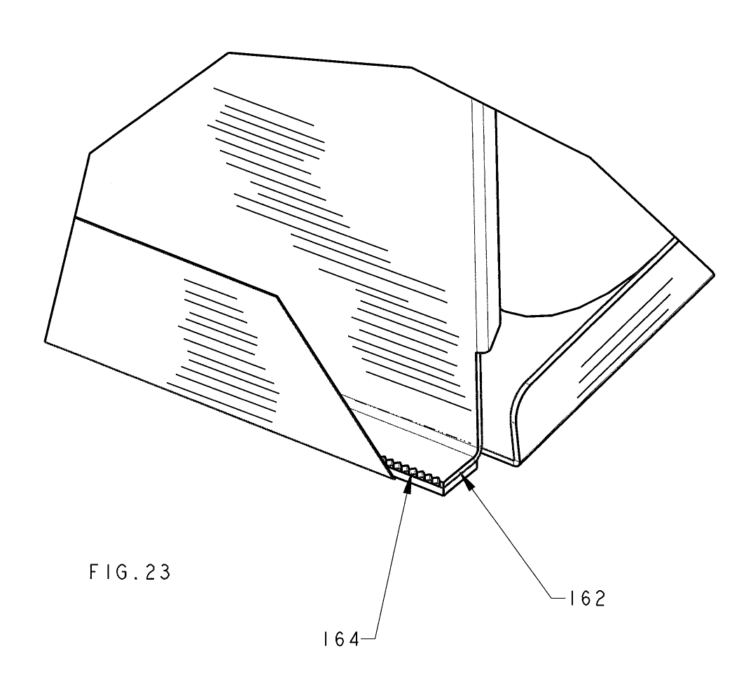

Finally, as an added feature to the described embodiments, the edge along which the paper is tore may be serrated or toothed. For example, as shown in FIG. 23, the lip 162 includes serrations 164 to tear paper as it is pulled upwards. Such an edge is most effective where the paper is not already perforated for tearing or where a smaller sheet of paper is suitable for a particular need.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A dispenser for material from a roll, the dispenser comprising:
a base;
a roll support extending from the base and positioned to retain a roll of material on the base in a rotatable state;
a tear bar attached to the base, extending substantially parallel to the roll support, and movable along and between a first position and a second position; and
a braking member coupled to the tear bar and responsive to the movement of the tear bar, wherein the braking member inhibits rotation of the roll of material when the tear bar is in one of either the first position or the second position.

2. The dispenser of claim 1, wherein the braking member is positioned within the roll support.

3. The dispenser of claim 1, further comprising a pivot attached to the base and about which the tear bar and the braking member move.

4. The dispenser of claim 2, further comprising a pivot attached to the base and about which the tear bar and the braking member move.

5. The dispenser of claim 3, wherein the pivot is positioned on a bottom-side of the base.

6. The dispenser of claim 1, wherein the roll support is fixed to the base.

7. The dispenser of claim 2, wherein the braking member frictionally engages an interior of the roll of material when the tear bar is in either of the first position and the second position.

8. The dispenser of claim 1, wherein the braking member prevents rotation of the roll of material when the tear bar is in either of the first position and the second position.

9. The dispenser of claim 1, wherein the braking member and the tear bar are a unitary component.

10. The dispenser of claim 9, wherein the braking member and tear bar further comprise a connecting member in which an integral pivot is formed for pivoting the braking member and the tear bar simultaneously.

11. The dispenser of claim 10, further comprising a biasing member attached to one of either the tear bar, the connecting member and the braking member to bias the tear bar and braking member into one of either the first position or the second position.

12. A dispenser for material on a roll, the dispenser comprising:
a housing having a base and a retaining surface;
a material feed opening defined between an edge of each of the retaining surface and at least another surface of the housing;
wherein the base is inclined at an angle such that a roll of material placed onto the base is biased by gravity toward and abutting the retaining surface.

13. The dispenser of claim 12, further comprising a tear bar attached to the housing at the material feed opening.

14. The dispenser of claim 13, wherein the tear bar has opposing ends and is pivotably attached between the ends to the housing.

15. The dispenser of claim 14, wherein the tear bar pivots to bias one end against the retaining surface of the base.

16. The dispenser of claim 15, wherein the tear bar pivots to block the feed opening.

17. The dispenser of claim 13, wherein the tear bar is detachable.

18. The dispenser of claim 12, further comprising a pivoting face plate attached to the retaining surface and defining an edge of the material feed opening.

19. The dispenser of claim 18, wherein the face plate is adjustable to alter a width of the material feed opening.

20. The dispenser of claim 12, further comprising a tear lip extending outward from the retaining surface.

21. The dispenser of claim 20, wherein the tear lip comprises a strip of material having a higher coefficient of friction than the lip.

22. The dispenser of claim 21, wherein the strip of material is made of a neoprene rubber.

23. The dispenser of claim 12, wherein the housing further comprises at least one additional surface to adjoin the base and the retaining surface.

24. The dispenser of claim 12, wherein an edge of the base defines the feed opening with the retaining surface.

25. The dispenser of claim 12, wherein the feed opening is defined by an edge of the retaining surface adjacent the base.

26. The dispenser of claim 12, wherein the feed opening is defined by an edge of the retaining surface distal to the base.
